(19) United States
(12) Patent Application Publication
(10) Pub. No.: US 2006/0165247 A1
(43) Pub. Date: Jul. 27, 2006

(54) Ambient and direct surround sound system

(75) Inventors: Warren Mansfield, San Rafael, CA (US); Steve Martz, San Rafael, CA (US); Andrew Poulain, San Rafael, CA (US); Michael Rudd, San Rafael, CA (US); Mark Tuffy, San Rafael, CA (US); Jerry Zernicke, San Rafael, CA (US)

Correspondence Address: CROCKETT & CROCKETT, 24012 CALLE DE LA PLATA, SUITE 400, LAGUNA HILLS, CA, 92653, US

(73) Assignee: THX, Ltd.

(21) Appl. No.: 11/339,163

(22) Filed: Jan. 24, 2006

Related U.S. Application Data
(60) Provisional application No. 60/646,755, filed on Jan. 24, 2005.
(60) Provisional application No. 60/658,959, filed on Mar. 3, 2005.

(51) Int. Cl. H04R 5/02; H04R 5/00

(52) U.S. Cl. 381/307; 381/19; 381/300

(57) ABSTRACT

Sound reproduction according to the present disclosure integrates an additional sound field, direct surround sound, to existing diffuse or ambient surround sound systems. Direct surround sound permits point source sounds to be located in an ambient or diffuse surround field and or to be moved within the surround field with control of the sound timbre. Sound mixing equipment may include two or more direct surround channels to permit sound designers and engineers to add, locate and move point source sounds within the surround field. The inclusion of two or more point source loudspeakers improves the surround array by providing direct sources that may be localizable and timbre matched to the screen channel speakers. This in turn provides filmmakers and other content creators a new tool they can use during the creation of content such as movie soundtracks. In another aspect of the present disclosure, a hybrid speaker may receive diffuse surround sound input and direct surround sound input and reproduce both sound fields from a single apparatus.

### RELATED APPLICATIONS

This application claims priority from copending U.S. Provisional Patent Application 60/646,755 filed Jan. 24, 2005 and copending U.S. Provisional Patent Application 60/658,959 filed Mar. 3, 2005.

### FIELD OF THE INVENTIONS

The inventions described below relate to the field of digital sound reproduction and more specifically to methods and apparatus for enhanced surround sound combining direct surround sound channels with diffuse surround sound channels.

### BACKGROUND OF THE INVENTIONS

From the first sound recordings ever made, technology has been changing in an effort to reproduce sound as it naturally occurs. Current sound systems have made great improvements from the sounds produced by early recording cylinders. There is still much improvement needed. Present technology still forces compromises when playing back content depending on the type of content. Cinema has generally employed direct sound in front of the audience and diffuse sound playback to present the ambient surround fields that place viewers in the scene. Music generally employs direct sound generators that better reproduce the musical performance and permit listeners to distinguish the locations of various instruments and or performers.

A diffuse field may generally be described as audio that comes from all directions. The diffuse field is created in a surround array by placing multiple loudspeakers along the walls. The result is that audio from the surround array arrives at the listener at different times. The differences in the arrival time cause comb-filtering effects, which is characterized by deep notches with respect to amplitude and rapid phase shifts with respect to frequency. The variations in arrival times and comb filtering create large distortions of spatial cues that degrade localization accuracy.

A diffuse sound field also has an impact on timbre. Timbre is mainly determined by the dynamic characteristics or loudness of sounds. Human hearing is not equally sensitive to sounds coming from different directions vs. one direction. For this reason, our perception of sound quality for a direct sound field and a diffuse sound field are different. The difference in sound quality perception may be characterized as a change in timbre when audio is panned from the screen channel to the diffuse surround array.

Conventional large venue replay systems are not capable of reproducing direct point source material in an ambient surround field using the current surround loudspeaker technology. Current surround systems are designed to envelop the audience by creating a diffuse surround field. The sound mixer therefore is unable to produce a sound event which circles the user with the required accuracy or with even timbre.

Small Venues such as clubs and home theater configurations further exemplify the compromises. A user for example may have a receiver and or pre-amplifier connected to a video display and one or more CD and or DVD players or other suitable device capable of reproducing two or more channels of sound and a set of speakers to present surround sound for movies and to play music. If the speakers are selected for optimum music playback, surround sound for cinematic presentations will not be suitable. Similarly, speakers selected to provide optimal surround sound for video programs will provide substandard music reproduction. Thus a user must have two different speaker systems and switch between them depending on the content to be presented. In this case, a game or other content that required point source sounds in the surround field may not be properly presented depending on the speaker set connected to the receiver during the presentation.

What is needed are methods and apparatus to allow the sound designer and mixing engineer the creative freedom to place audio elements in more locations in the surround field. A direct/ambient replay system according to the present disclosure adds an additional sound field to existing surround sound systems and may also include new sound generating hardware and software processing to allow backward compatibility of these new expanded channel audio soundtracks in conventional cinemas.

### SUMMARY

Sound reproduction according to the present disclosure integrates an additional sound field, direct surround sound, to existing diffuse or ambient surround sound systems. Direct surround sound permits point source sounds to be located in an ambient or diffuse surround field and or to be moved within the surround field with control of the sound timbre. Sound mixing equipment may include two or more direct surround channels to permit sound designers and engineers to add, locate and move point source sounds within the surround field. The inclusion of two or more point source loudspeakers improves the surround array by providing direct sources that may be localizable and timbre matched to the screen channel speakers. This in turn provides filmmakers and other content creators a new tool they can use during the creation of content such as movie soundtracks.

Throughout this application the number of channels available and allocated is for example only and is based on current practice, standards and available technology. More or fewer channels may be used to add and integrate a direct surround field with a diffuse surround field, the combination when presented in addition to a front or screen sound field operates as an ambient direct sound system.

In a first aspect of the present disclosure, a hybrid speaker may receive diffuse surround sound input and direct surround sound input and reproduce both sound fields from a single apparatus.

In another aspect, reproducing point source sounds in a surround sound field according to the present disclosure provides direct radiating speakers in specific portions of the surround field. These direct radiating speakers have performance characteristics similar to that of the screen channel speakers preserving the timbre of sounds as they are played through these systems. An ambient direct sound configuration according to the present disclosure produces two distinct surround sound fields to accommodate the replay of diffuse ambient material, diffuse surround sound, as well as direct sound effects, direct surround sound.

The combined use of both diffuse surround sound and direct surround sound may be suitable for use in cinema presentations as well as games, music, sports, concerts and other audio content in any suitable venue.

An ambient direct surround sound configuration according to the present disclosure splits the traditional surround array into a minimum of two diffuse surround or ambient array channels, left and right, along with the embedding of two or more direct surround or direct radiating channels in the surround array. For example, using two or more direct radiators, one is placed on each side wall, and optionally, one or more may be placed on the rear wall. Using 4 direct radiators, one direct radiator is placed on each side wall, and two on the rear wall.

Each of the two or more direct channels in the surround field may include Bass Management separate from the front screen channels. The output of the direct sound channel bass management may be provided to a dedicated surround subwoofer replay system. Therefore, a sound system according to the present disclosure may include the ability to have 1 or more independent LFE channels.

In another aspect, the present disclosure allocates additional surround channels allowing for two or more direct radiator speakers in the surround field. This partitioning allows for example, 9 channels of surround information to be present in a cinema, game or other suitable content. For configurations which have fewer than 9 surround channels, such as 5.1, 5.1 EX, 6.1 and others, sections of either diffuse surround channels or direct surround channels may be combined or linked to allow replay of the content.

In a further aspect of the present disclosure a cinema hybrid direct and diffuse speaker is provided for reproduction of both ambient and direct sound channels in a single device. Using the new hybrid ambient direct field speakers, venues may implement the ambient direct sound field techniques to bring improved surround sound and enhanced capabilities by replacing two or more of the loudspeakers used in the conventional ambient arrays with two or more hybrid direct and diffuse speakers.

In still another aspect, the present disclosure includes a hybrid monopole and dipole speaker for reproduction of both ambient and direct sound channels in a single device. Using the new hybrid ambient direct surround speakers, home theater venues may implement the ambient direct sound field techniques to bring improved surround sound and enhanced capabilities to small venues such as home theater.

In still another aspect, the present disclosure includes a Digital cinema 12 channel speaker system having
3 front direct speakers generally behind the screen (Left, center, right)
3 surround ambient speaker arrays (Left, right and rear)
4 direct speakers (Left, right, left rear, right rear)
2 subwoofers, 1 for LFE and 1 for surround

In another still further aspect, the present disclosure includes a home theater ambient direct sound system including
3 front speakers
2 ambient-direct speakers, each powered by 2 amplifier channels
2 ambient-direct speakers, each powered by 2 amplifier channels
1 or 2 subwoofers.
Result—eight or nine speakers, powered by 12 or more amplifier channels

Ambient direct sound systems according to the present disclosure may also expand the number of mix stems that may be used in the production of content for playback in the cinema, or other suitable venue, from 6 (5.1) to a maximum of 14 (12.2). This content may be a movie soundtrack, a musical event, broadcast TV audio or a video game. Beyond this though, ambient direct sound systems enhance production for multichannel content for the cinema by allocating extra content channels for the placement of direct surround information.

Sound systems according to the present disclosure allow extra creative freedom by allowing 14 stems (instead of 6) on a mixing console to be used for content creation, up to 6 of which are dedicated for the placement of direct elements in the surround field. The 14 channels may be configured as follows:
3 front channels L, C, R (5 if Left center and right center are used).
Two or more ambient surround channels SLA, SRA (as provided in cinema).
Two additional rear ambient surround array channels, SBRA and SBLA, which allows a single rear surround channel to be split in two halves and aids the fold-down mixing for systems with fewer speakers.
4 direct surround channels SLD, SBLD, SBRD, SRD (6 if left of center/right of center are not used).
1 LFE Channel, 2 may be used when separate LFE content is produced for the back direct surround channels.

A mixing console including a surround panner configured according to the present disclosure allows sound mixer access to a minimum of 7 direct sound channels distributed through out the system. The newly provided direct surround busses allow the mixer to place deliberately localizable FX or audio elements in these channels. These elements are distinct from the surround array busses in which elements are placed to create an ambient environment within the theater. All 14 of the channels may be output by the mixing console as discrete elements and recorded as 14 digital or analog channels, no combination of the channels (addition or matrixing) is undertaken during recording.

In order to allow verification of the integrity of the audio content for presentation on older playback systems, a mixing console may include a dynamic downmix algorithm. The downmix algorithm continually analyzes the content in each of the surround channels to ensure that the downmix maintains the correct relative levels of the individual elements when they are combined. This algorithm may also be used in a cinema processor that mirrors the downmix heard in the mixing studio.

An ambient direct audio system according to the present disclosure may also include dynamic signal processing.

Dynamic upmix allows for non-cinema or legacy 5.1 film content to be played back in the Ambient Direct format if specified by the content creator. This would dynamically upmix the content up to the Ambient Direct playback system format.

It is entirely possible that a digital playback device may be installed in an auditorium where there is not an Ambient Direct playback system, In this case a dynamic downmix may be applied to the content to allow playback over the x.1 playback system, while preserving the integrity of the content. This processing would be activated by default when a full Ambient Direct system is not present.

According to the present disclosure, all recorded content is in the 14 channel format, and processing to adapt it to the replay system is included in a cinema or home theater receiver processor. This prevents the need to produce separate mixes for venues that may have less than 14 channels of replay capability.

Ambient direct sound systems according to the present disclosure may also expand the number of mix stems that may be used in the production of content for playback in the cinema, or other suitable venue, from 6 (5.1) to a maximum of 14 (12.2). A mixing console including a surround panner configured according to the present disclosure may provide a sound mixer access to a minimum of 7 direct sound channels distributed through out system. The newly provided direct surround busses allow the mixer to place deliberately localizable FX or audio elements in these channels. These elements are distinct from the surround array busses in which elements are placed to create an ambient environment within the theater

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 is a plan view of a cinema venue incorporating ambient direct surround sound according to the present disclosure.

FIG. 2 is a plan view of a home theater incorporating ambient direct surround sound according to the present disclosure.

FIG. 2A is a top view of a hybrid ambient direct small venue speaker according to the present disclosure.

FIG. 2B is a front view of the hybrid speaker of FIG. 2A.

FIG. 2C is a side view of the hybrid speaker of FIG. 2A.

FIG. 3 is a side view of a direct surround speaker according to the present disclosure.

FIG. 4 is a front view of the direct speaker of FIG. 3.

FIG. 5 is a plan view of a sound studio according to the present disclosure.

FIG. 6 is a front view of combined direct and ambient surround speakers.

FIG. 7 is a block diagram of an example of an ambient direct sound presentation system according to the present disclosure.

### DETAILED DESCRIPTION OF THE INVENTIONS

In a direct ambient sound system according to the present disclosure, 12 channels or 11.1 using conventional notation, of information are created during a sound recording mixing process. This recording is then encoded onto a cinematic carrier medium or any other suitable recording medium and then ultimately transferred to any suitable consumer medium such as a CD, DVD, broadcast, or other using an encoding CODEC. This CODEC could either encode all 12 channels discretely, as 11.1, or it could be downmixed to 5.1 channels.

The 12 channels, or downmixed 5.1, would be applied to a receiver/pre-amplifier on a standard multichannel carrier such as DTS, DTS-HD, Dolby Digital, Dolby Digital Plus, etc. The receiver would accept the carrier and in the case of the 5.1 downmixed source, would expand to the original 12 channels.

The receiver/pre-amplifier or cinema controller would route internally into the gain structure of the hardware and may apply post-processing such as for example bass management accordingly.

The pre-amplifier shall provide the following outputs:

| | |
|---|---|
| Front Lt | Surround Back Rt Ambient |
| Front Ctr | Surround Back Rt Direct |
| Front Rt | Surround Back Lt Ambient |
| Subwoofer | Surround Back Lt Direct |
| Surround Rt Ambient | Surround Lt Ambient |
| Surround Rt Direct | Surround Lt Direct |

If hardware limitations, legacy configurations or for other reasons the user is not able to present all 12 channels, downmix of channels may be accomplished to provide the most suitable presentation. For example, if the user does not have any Surround Back speakers, the surround back right ambient channel shall be downmixed into the surround right ambient channel and the surround back right direct channel shall be downmixed into the surround right direct channel.

Alternatively, metadata may be included in the content recording. According to this disclosure, metadata may be used to control sound processor configuration to accomplish upmixing, downmixing, or any other suitable channel processing to achieve a desired presentation.

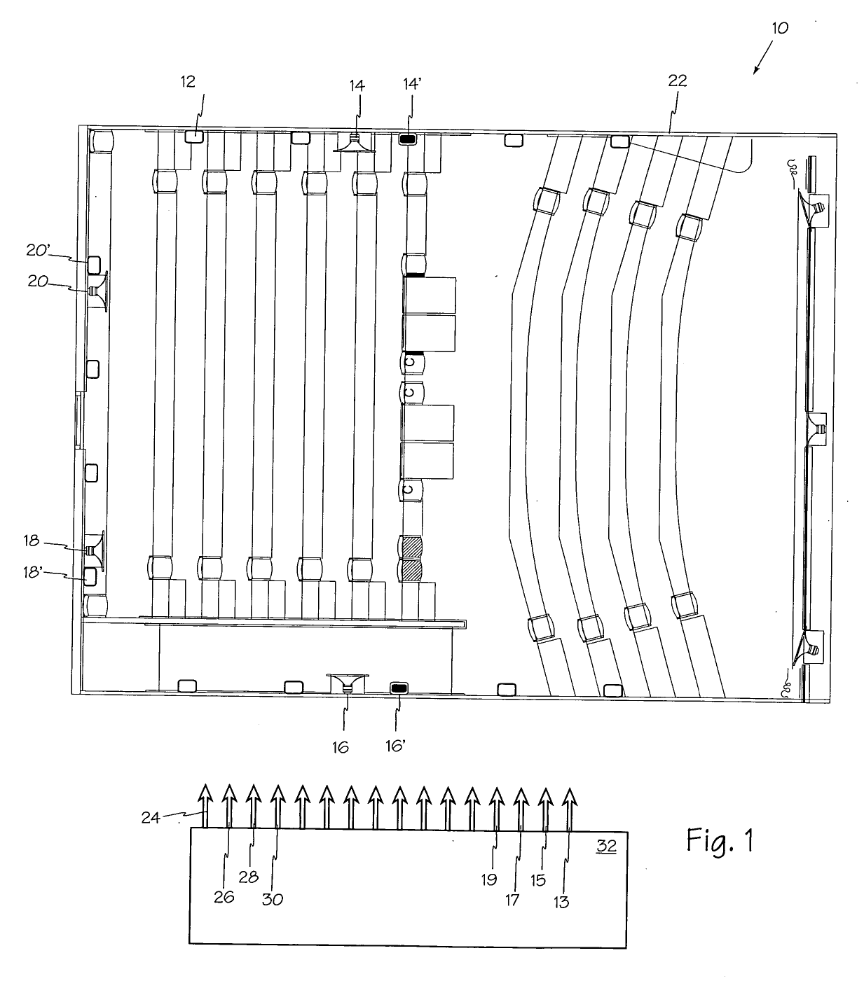

Referring now to FIG. 1, an ambient direct sound system 10 according to the present disclosure in venue 22 may include two or more diffuse or ambient surround channels presented through any suitable speakers such as speaker 12 as well as two or more direct surround channels presented through speakers such as left direct speaker 14, right direct speaker 16, and rear direct speakers 18 and 20. Direct speakers such as direct speakers 14, 16, 18, and 20 may receive direct sound signals 24, 26, 28, and 30 respectively from sound management system 32.

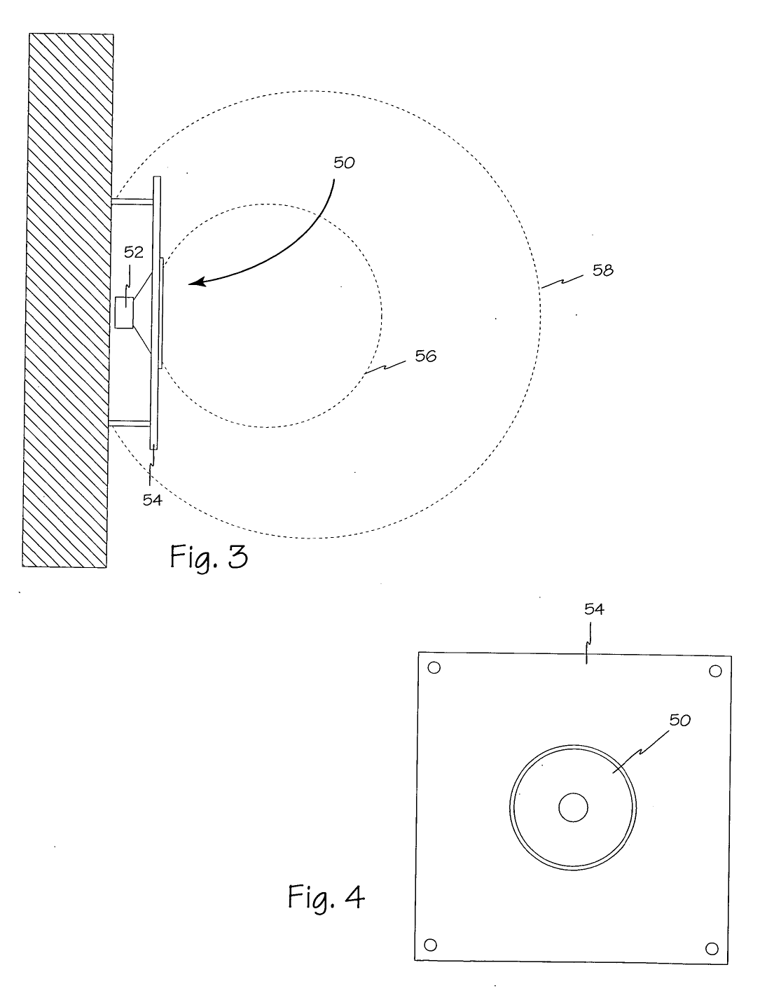

Referring now to FIG. 3 and FIG. 4, A suitable speaker configuration for a direct surround speaker may use a conventional movie-theater loudspeaker driver 52, but instead of mounting it in a box, it is mounted on a flat plate 54, which may operate as a baffle. For a speaker which operates down to 80 Hz, baffle 54 may be approximately 3 feet across and spaced about 6 inches from the wall. Speaker 50 may be mounted high up on either a side or a rear wall of a venue. A listener directly below speaker 50 will hear not only the sound from the front of the driver front wave 56 but also the sound from the back, back wave 58. Front wave 56 will be 180 degrees out of phase with back wave 58 and thus the two sounds will cancel and the listener will hear very little.

If a listener were directly in front of speaker 50, they will hear both front wave 56 and back wave 58, delayed by the time it takes for the sound to travel around baffle 54 which may be about 1.6 milliseconds for a baffle 3 feet across. The two waves will now not cancel completely, because of this time delay. For example at 80 Hz they will only cancel by half, or 6 dB attenuation. At 320 Hz they will actually add and double the sound output providing a 6 dB boost. Equalization may be required to “flatten” the loudspeaker response. At 640 Hz, the front and back waves will again cancel, but at and above this frequency a cross-over may be provided from the driver to a conventional directional midrange horn-driver or array.

To summarize the performance, listeners below the axis of the loudspeaker will not hear as much of its output as those listeners nearer to the axis of the loudspeaker. This “directivity” is used to compensate for the different distances of the listeners. The distant listeners would normally hear a weaker sound but they are closer to the loudspeaker axis, which compensates for their distance. Thus all listeners will hear approximately the same intensity of the sound, no matter their distance from the loudspeaker.

Alternatively, conventional ambient field speakers such as speaker 12 may be replaced by hybrid ambient direct speakers such as hybrid speakers 14′, 16′, 18′ and 20′. Hybrid ambient direct speakers such as hybrid speakers 14′, 16′, 18′ and 20′ may also obviate the need for direct speakers 14, 16, 18, and 20. Hybrid speakers 14′, 16′, 18′ and 20′ may receive direct sound signals 24, 26, 28, and 30 respectively as well as ambient surround signals 13, 15, 17, and 19 respectively from sound management system 32.

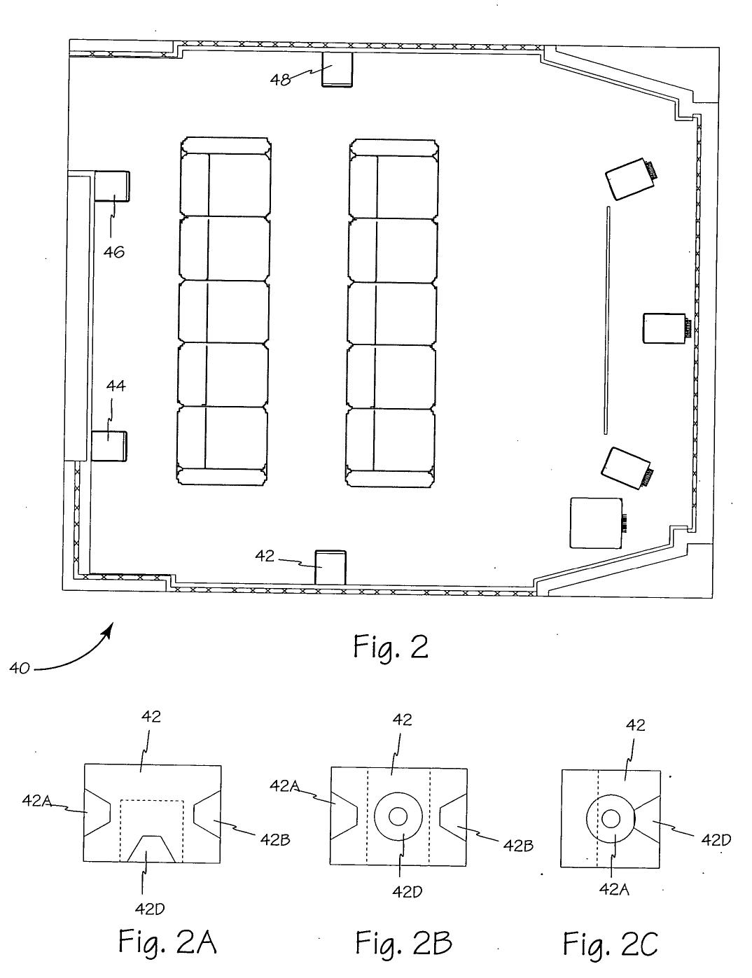

In small venues a user may have separate speakers for the ambient surround channels and the direct surround channels similar to large venues. Referring now to FIG. 2, in an alternative configuration any small venue such as home theater 40 may incorporate two or more hybrid monopole dipole speakers such as mono-dipole speakers 42, 44, 46, and 48.

Referring to FIGS. 2A-2C, a hybrid speaker according to the present disclosure such as mono-dipole speaker 42 may reproduce both ambient channel information using diffuse surround elements 42A and 42B and direct channel information with direct element 42D.

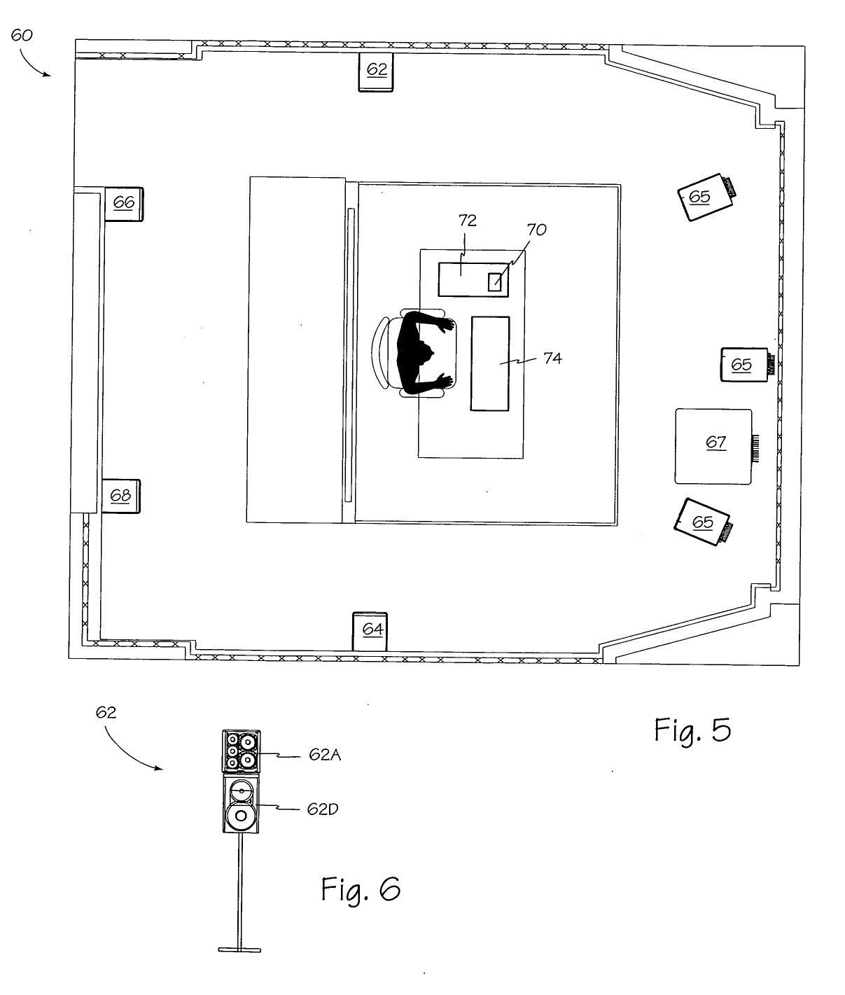

For production of suitable sound having a direct front sound field, a diffuse surround field and a direct surround field a sound designer or engineer may use any suitable sound studio such as studio 60 of FIG. 5. Studio 60 may include two or more side surround elements such as left surround element 62 and right surround element 64, and one or more rear surround element such as left rear surround element 66 and right rear surround element 68. Each surround element may be composed of an ambient component such as ambient component 62A and a direct component such as direct component 62D as shown in FIG. 6.

Studio 60 may also include three or more front sound elements such as speakers 65 for reproduction of the three or more front sound channels, and one or more low frequency components such as subwoofer 67. A sound designer may use software 70 of computer 72 together with mixing hardware 74 to produce 12 channels of ambient direct sound.

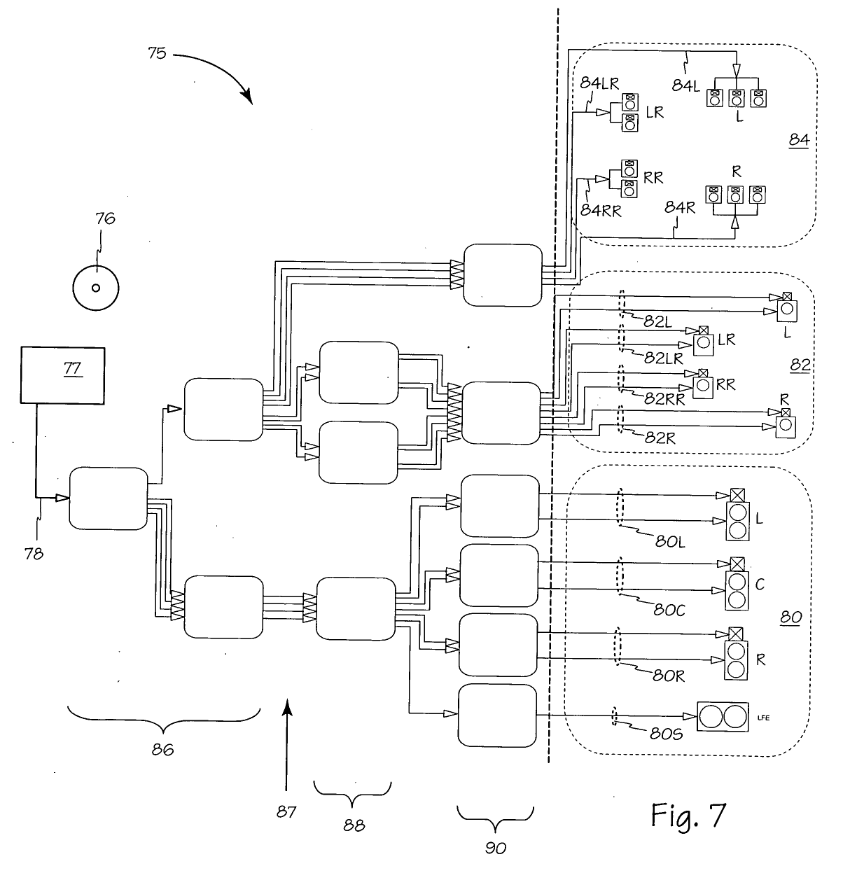

Referring now to FIG. 7 in ambient direct sound system 75, recorded media 76 may be read or otherwise processed by player 77. 12 channels of sound information such as sound information 78 are produced by recorded media 76 in player 77. Sound information 78 may produce a front or screen sound field 80, a direct surround field 82 and a diffuse surround field 84. Processing stage 86 may produce twelve channels 87 of sound information which is further processed in crossover stage 88 and then amplified by amplifier stage 90.

Each surround sound field may be formed by four channels of sound. Ambient or diffuse surround field 84 is produced by a left channel 84L, a right channel 84R, and one or more rear channels such as left rear channel 84LR and right rear channel 84RR. Direct surround field 82 is produced by a left channel 82L, a right channel 82R, and one or more rear channels such as left rear channel 82LR and right rear channel 82RR. Front or screen sound field may be produced by three direct sound channels such a left channel 80L and right channel 80R and center channel 80C. Low frequency sound is produced by LFE channel 80S.

Thus, while the preferred embodiments of the devices and methods have been described in reference to the environment in which they were developed, they are merely illustrative of the principles of the inventions. Other embodiments and configurations may be devised without departing from the spirit of the inventions.

We claim:

1. An audio content replay system comprising:
means for processing recorded audio content to yield three or more channels of front audio information and two or more channels of diffuse surround audio information and two or more channels of direct surround audio information;
means for presenting the three or more channels of front audio information;
means for presenting the two or more channels of diffuse surround audio information; and
means for presenting the two or more channels of direct surround audio information.

2. A method of presenting audio content comprising the steps of:
extracting pre-recorded audio information from recorded content media;
processing the pre-recorded audio information to yield three or more channels of front sound information and two or more channels of diffuse surround sound information and two or more channels of direct surround information;
conveying each of the three or more front sound channels to a separate front speaker means;
conveying each of the two or more diffuse surround sound channels to separate means for producing diffuse sound;
conveying each of the two or more direct surround sound channels to separate means for producing direct sound;
